(19) United States
(12) Patent Application Publication
(10) Pub. No.: US 2023/0416115 A1
(43) Pub. Date: Dec. 28, 2023

(54) Pressurization System for Portable Water Filters

(71) Applicant: John Robert Masotta, Ridgefield, CT (US)

(72) Inventor: John Robert Masotta, Ridgefield, CT (US)

(21) Appl. No.: 18/214,746

(22) Filed: Jun. 27, 2023

Related U.S. Application Data
(60) Provisional application No. 63/356,431, filed on Jun. 28, 2022.

(51) Int. Cl. C02F 1/00; B01D 35/26

(52) U.S. Cl. CPC C02F 1/002; B01D 35/26; C02F 2201/005; C02F 2301/066; C02F 2307/02; B01D 2201/202

(57) ABSTRACT

A pressurization system may be disposed below a standard water bottle containing dirty water or water obtained from a stream or lake as often found when camping or backpacking. The pressurization system may comprise a pump bulb or other means of pressurizing an inner void, the inner void defined by the pressurization system and disposed below the dirty water and disposed above a filtration system. Upon squeezing the bulb, a supply check value introduces pressurized air into the inner void, the pressurized air forcing dirty water into and through the water filtration system. Upon release of the bulb, a negative pressure within the bulb opens return valve drawing air into the bulb through a return air void. The disclosed embodiments do not require squeezing or deforming a container of dirty water and may be placed in fluid connection with standard water bottles and water filters.

### RELATED PATENT APPLICATION AND INCORPORATION BY REFERENCE

This utility application claims the benefit and priority of application 63/356,431 filed on Jun. 28, 2022, the contents of which are incorporated herein by reference as if restated in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to portable water filtration systems. More particularly, the invention relates to the means and methods of introducing pressure within a filtration system to increase filtration performance and ease of use.

### (2) Description of the Related Art

Portable water filters are well known in the prior art and used extensively for backpacking, camping, and emergency/survival situations. There are several types available. Some designs have integrated pumps to allow the user to generate enough pressure to effectively pass the water through the filter. Such prior art examples include the MSR Miniworks and MSR Guardian purifiers. These designs are highly effective; however, they are bulky and comprise relatively heavy and numerous parts and components that may break or fail. These designs are not preferred for lightweight backpacking where light weight, compact size, and simplicity of design are desired.

The known prior art also includes a “Squeeze water filtration system” by Sawyer. Flexible bag systems of the known prior art, such as the Sawyer system, rely upon a flexible bag to contain the dirty (unfiltered) water. The flexibility of the bags allows the user to squeeze the bags, creating pressure within the system to force the water through the filter element and come out the other side clean filtered water. Due to the very fine filter pore size (typically 0.1 micron or less), a large amount of force on the bag is required to create enough pressure to move the dirty water through the filter. The force and pressure required will increase as the particulate within the dirty water clogs the pores within the filter. Applying this additional force can be difficult for users who do not have sufficient strength or dexterity. Over time, repeated squeezing and high force will cause the bag to burst and fail, rendering the bag useless. Most users carry an additional bag or two when in the back country so as not to be left without a way to make clean water. These bags are proprietary items and are available only from specialized retailers.

The known prior art also includes attempts by some users to get around the bag system by using a disposable plastic water bottle for both the dirty and clean sides of the system. An advantage of this prior art system is that water bottles are readily available anywhere water or drinks are sold (gas stations, convenience stores, even recycling bins!) and most backpackers are already carrying several to store enough water for use on any given trip.

There are several drawbacks to using a bottle on the dirty side, which may include:
1. Bottles, unlike bags, do not compress flat. To filter an entire bottle of water requires the user to periodically unscrew the dirty water bottle, flip it right side up, and allow air to enter the bottle so the bottle can regain its original shape. Not only does this add considerable time to the overall process, it presents a potentially unsanitary situation, as the user must repeatedly handle both the dirty and clean water bottle multiple times during the filtering process.
2. Over time, the bottles too will develop creases and cracks and will fail just like the bags.

### BRIEF SUMMARY OF THE INVENTION

Disclosed embodiments may be considered a lightweight, portable hand-powered device to assist in pumping unfiltered water through a commercially available water filter and connecting to commercially available disposable water bottles.

Disclosed embodiments may comprise a self-contained device containing a rigid housing with sealed connections to a disposable water bottle on one end and a water filter on the other end. A flexible bulb enters the housing between the end connections, as a means to introduce higher pressure air into the system. Check valves may be incorporated into the rigid housing and/or the flexible bulb.

The present invention overcomes shortfalls in the related art by presenting an unobvious and unique combination, configuration and use of bulb pump systems, integrated check valves or one-way valves and artful configurations that eschew the prior art's penchant for squeeze bags and squeeze bottles and high exertion in pushing dirty water through filters that require greater water pressure as contaminates impede water flow.

The disclosed embodiments overcome short falls in the known prior art by enabling the following benefits:

Utilizes a small hand operated bulb (similar to the blub on a blood pressure cuff) to introduce air into the dirty water bottle, building pressure which pushes the water through the filter and into the clean bottle.

Eliminates the need to remove the bottles from the system until the filtering process is completed.

Eliminates the need to deform the bottle, increasing the useful lifetime of a single bottle.

Produces higher pressure to filter the water without requiring additional strength on the part of the user.

Novel features or points of novelty of the disclosed embodiments include:

Compact, lightweight device that fits between the dirty water bottle and the existing water filter.

Two integrated check valves (also called one-way valves):

A first check valve allows air into the dirty bottle when the bulb is squeezed, but the first valve prevents water and air from coming back into the bulb.

A second check valve allows fresh air from the atmosphere or ambient air back into the bulb as the bulb returns or inflates to its original state, but the second valve blocks the contained ambient return air from exiting back to the atmosphere.

When properly operated with the dirty bottle mounted upside-down, gravity does the work forcing the air up (into the bottom of the upside-down bottle). As more and more air builds, the pressure increases and forces the dirty water down and through the water filter.

As the filter gets dirty and more pressure is required, a few more squeezes of the bulb will increase the pressure and continue to push the water through the filter.

### BRIEF DESCRIPTION OF THE DRAWINGS

FIG. 1 is a perspective view of a prior art system

FIG. 2 is a perspective view of a prior art system

FIG. 3 is an elevational view of a disclosed embodiment

FIG. 4 is a sectional view of a disclosed embodiment

FIG. 5 is front view of a disclosed embodiment integrated with prior art components

FIG. 6 is a sectional view of a commercially available water filter of the prior art

FIG. 7 is a sectional detail of a disclosed embodiment in use

FIG. 8 is a sectional detail of a disclosed embodiment in use

FIG. 9 is a sectional view of a disclosed embodiment in use

FIG. 10A is a perspective view of a “duckbill” style check valve

FIG. 10B is a sectional detail of a “duckbill” style check valve in a closed position

FIG. 10C is a sectional detail of a “duckbill” style check valve in an open position

FIG. 11 is a sectional view of an alternate disclosed embodiment

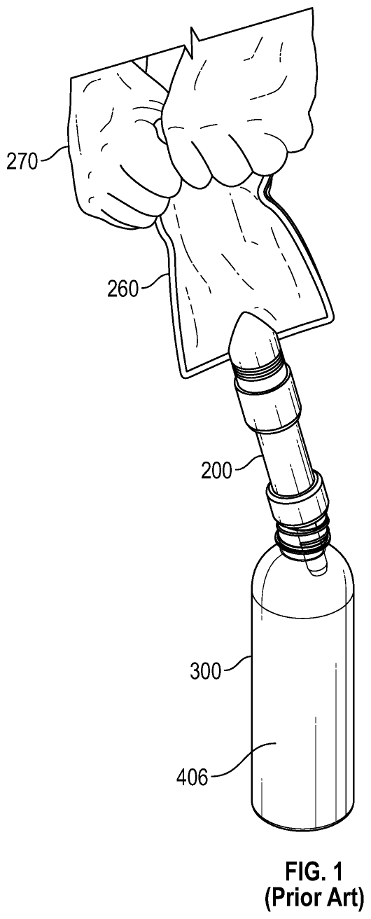

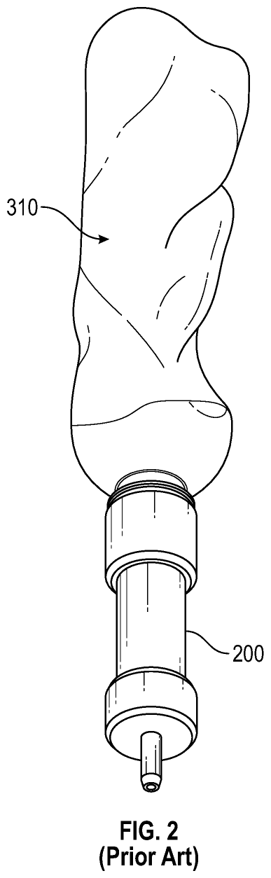

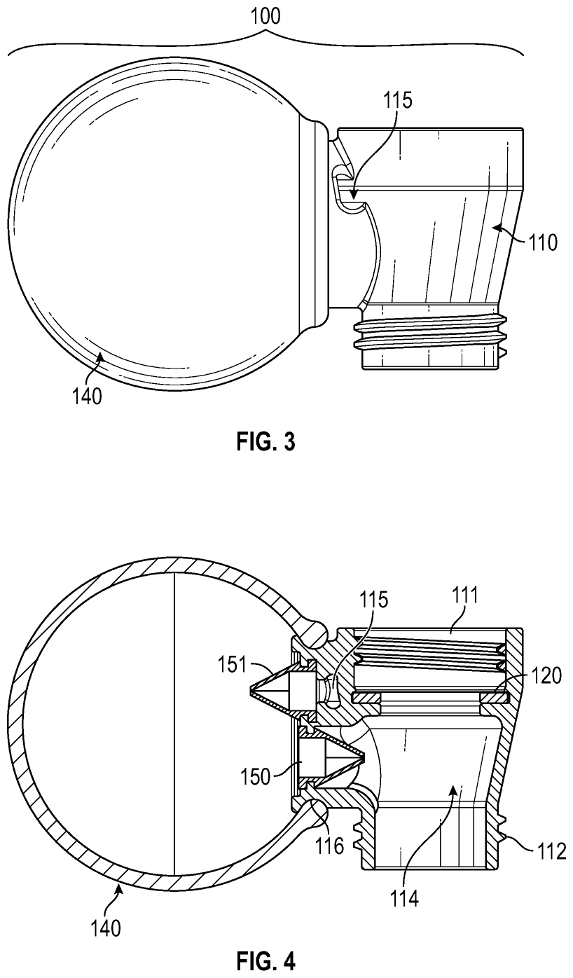

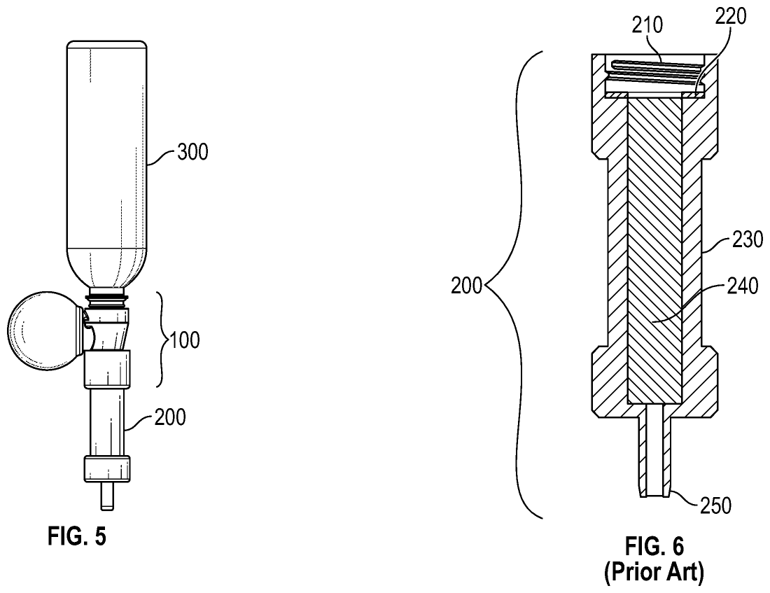

### REFERENCE NUMERALS IN THE DRAWINGS

100 disclosed embodiment
110 housing
111 inlet connection
112 outlet connection
114 inner void defined within housing 110
115 return air void, defined within housing connecting return check valve to atmosphere
116 bulb retaining groove
120 inlet sealing gasket
140 pump bulb
150 supply check valve
151 return check valve
200 water filter (commercially available, prior art)
210 filter inlet connection
220 filter inlet gasket
230 filter housing
240 filter media
250 filter outlet
260 water filter bag (commercially available, prior art)
270 force exerted on bag by user
300 disposable water bottle (commercially available, prior art)
310 disposable water bottle (failed) prior art
400 squeeze force exerted on pump bulb by user
401 air contained within a pump bulb
402 path of pressurized air through a disclosed embodiment
403 pressurized air in a disposable water bottle
404 unfiltered water in a disposable water bottle
405 path of water through a disclosed embodiment
406 clean filtered water
407 restoring force supplied by a pump bulb
408 path of atmospheric air to refill a pump bulb
409 direction of gravity when in use
503 Higher pressure air
504 Lower pressure air
505 Higher pressure water
506 Lower pressure water
507 Force created by higher pressure air to close valve
508 Force created by higher pressure water to close valve
509 Force created by higher pressure air to open valve

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

Narrative Description

A disclosed embodiment 100 may comprise a rigid housing 110 made of molded or printed plastic, or some other lightweight, high strength material. On one end, the housing 110 features an inlet connection 111 comprising female screw threads to mate to the male screw threads of a typical disposable water bottle 300. This interface also contains a sealing gasket 120 made of rubber or similar soft compound, to ensure an air and watertight connection. On the opposite end, housing 110 features an outlet connection 112 comprising male screw threads to mate to the female screw threads 210 found on a commercially available water filter 200. Water filter 200 is supplied with a gasket 220 to ensure an air and watertight connection. Housing 110 also defines an inner void 114 which connects the two ends of the housing and allows water and air to pass freely. Housing 110 contains a bulb retaining groove 116 or similar feature to capture the pump bulb 140 and ensure that the bulb is retained during use without falling off or leaking.

Pump bulb 140 may be made from rubber or a similar soft but resilient material. When squeezed, it is important that the bulb returns to its original shape when released.

Check valves are well known in the art. Check valves operate by opening and closing via pressure differential on either side of the valve. Typically, a check valve or one way valve will only allow flow in one direction, and only when the pressure on the upstream side is higher than the pressure on the downstream side. When the pressure reverses or equalizes, the check valve will close and will not allow flow in the reverse direction. There are many types of check valves available and known in the art. Some have balls or plungers held in place by springs which provide the restoring force when pressure is balanced across the valve. Other types of valves are made of silicone rubber or other resilient materials and provide their own restoring force by their shape and the properties of the material. In the preferred embodiment, one piece silicone rubber “duckbill” style valves are shown. However, different types of valves could be used with similar results.

In the preferred embodiment, housing 110 has two integrated “duckbill” style check valves. This valve is selected for its low cost, ease of mounting, and simple one-piece construction. A supply valve 150 allows higher pressure air into the system, or more particularly the inner void 114, but prevents water and air from exiting the housing. A return valve 151 allows fresh ambient or atmospheric air in to refill the pump bulb 140, but does not allow high pressure air to escape to the atmosphere when the pump bulb 140 is squeezed.

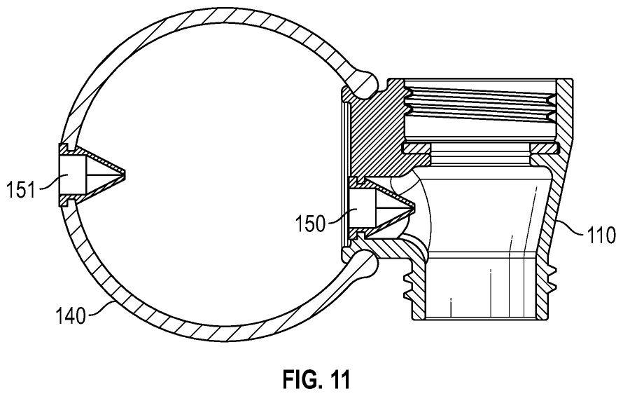

In an alternate embodiment, the return valve 151 can be mounted or molded directly in the pump bulb 140, as shown in FIG. 11.

A disclosed embodiment may function in the following manner:

User fills bottle 300 with dirty water 404 to be filtered.

User connects outlet connection 112 to filter inlet connection 210 and tightens against filter inlet gasket 220.

User connects inlet connection 111 to bottle 300 and tightens against inlet sealing gasket 120.

User inverts the completed assembly so the bottle 300 is on top, and upside down.

User directs the filter outlet 250 into a suitable clean receptacle (typically a clean water bottle).

User exerts force 400 to squeeze pump bulb 140 repeatedly. With each squeeze of the pump bulb 140, the following happens:

The pressure of the air 401 inside the bulb 140 increases due to the shrinking volume inside the pump bulb 140.

Return check valve 151 closes due to the force 507 created by the higher-pressure air 503 inside of the pump bulb 140 than in the outside atmosphere. The opposite side of return check valve 151 is connected to atmosphere through the return air void 115 in housing 110.

Supply check valve 150 opens due to force 509 created by the higher-pressure air 503 inside of the pump bulb than the lower pressure water 506 inside the housing 110.

Air is forced through supply check valve 150 into housing inner void 114 which is filled with dirty water 404.

The air will form bubbles, and gravity 409 will force the air bubbles to rise 402 into the bottle 300, forming a pocket of pressurized air 403 within the bottle 300.

User releases the bulb 140 and restoring force 407 returns the bulb to its previous shape.

The restoring force lowers the pressure of the air 401 in the pump bulb 140 due to the expanding volume inside the pump bulb 140.

Supply check valve 150 closes due to force 508 created by the higher-pressure water 505 inside of the housing inner void 114 than the lower pressure air 504 inside the pump bulb 140.

Return check valve 151 opens due to the force 509 created by the higher-pressure ambient or atmospheric air 503 in the return air void 115 than inside pump bulb 140. The opposite side of return check valve 151 is connected to atmosphere through return air void 115 in housing 110. The ambient air refilling pump bulb 140 becomes the air 401 for the next pump cycle.

This concludes one pump cycle. User will continue to squeeze and release the pump bulb 140.

As the air 403 increases pressure with each pump cycle, the air pushes on the water 404 within the bottle 300, forcing the water down 405 through the filter media 240.

A stream of clean filtered water 406 exits the filter outlet 250 and into a clean receptacle.

User continues to pump until bottle 300 is empty and all water is clean and filtered.

A disclosed embodiment may also be described as follows:

A water bottle 300 or other container may contain dirty water or water obtained from a stream or lake, as typically found while camping. The water bottle may be in an upright position, and then screwed or otherwise attached to a disclosed pressurization system 100 such that the water bottle and pressurization system are in fluid connection. A top lip of the bottle may be disposed upon or urged into a flexible inlet sealing gasket 120. The bottle and pressurization system 100 may be in threaded or screwed connection or other means of connection. The bottle may be considered to be in fluid connection with a top end or superior end of the pressurization system, since when in use, the bottle will be on top of the pressurization system.

A filter 200 may be in fluid connection with lower or inferior end of the pressurization system. The terms “lower” or “inferior” are relative to the superior end that may be attached to the water bottle. For descriptive purposes herein, the terms “lower” or “inferior” are relative and presume that a disclosed embodiment is ready for use, with the water bottle on top and water filter on bottom so as to take advantage of gravity to assist in directing the pressurized air up, forcing the dirty water down through the filter media. The disclosed embodiments work with gravity and add pressure upon the dirty water to speed up the flow of dirty water through the filter.

A filter 200 may be screwed or otherwise attached in fluid connection by use of female threads 210 of the filter mating with male threads 112 of the pressurization system. Other means and methods are contemplated.

After fluid attachment of a water bottle 300 and filter 200 to a disclosed embodiment, a user may assist in moving dirty water though the filter by adding pressure to the downward flow of water by squeezing a pump bulb 140. A pump bulb may be in frictional or elastic attachment upon or within a bulb retaining groove 116. A bulb retaining groove 116 may comprise an open circular void defined by a lateral side of the pressurization system. The bulb retaining groove may be defined or disposed in a manner that encircles or encompasses the return check valve 151 and supply check valve 150. Other attachment means and methods are contemplated.

Upon squeezing the pump bulb 140, air pressure increases within the bulb causing the supply check valve 150 to open, allowing the air of the bulb to enter an inner void 114, the inner void defined by the outer walls of the housing 110. The added air or air pressure within the inner void, is applied to water inside the bottle, the water is then further urged into and through the down stream filter. At this point, the bulb is distorted as a result of having less air volume. The challenge is to add air back into the bulb without a loss of air pressure within the inner chamber or deforming the bottle. Thus, a second valve or air return valve or return check valve 151 is also disposed within the bulb. In order to draw air back into the bulb so as to not deform the bottle or reduce air pressure or water pressure applied to the filter, a return air void 115 is in fluid connection with ambient air. The return air void is also in fluid connection with the return check value 151. The return check valve opens as a result of negative air pressure occurring upon release of the compressed pump bulb, allowing ambient air from the return air void to refill the bulb. The negative pressure within the bulb works to further close the supply check valve 150.

The return air void 115 is defined by the housing and the return air void may be an air passageway with a first end disposed within or defined within the return check valve and the air passage having a second end outside of the bulb with the second end in fluid communication with the ambient air via the return air void with the return air void being outside of the bulb.

The bulb or pump bulb 140 may be made of resilient material that restores to an original spherical or similar shape after compression.

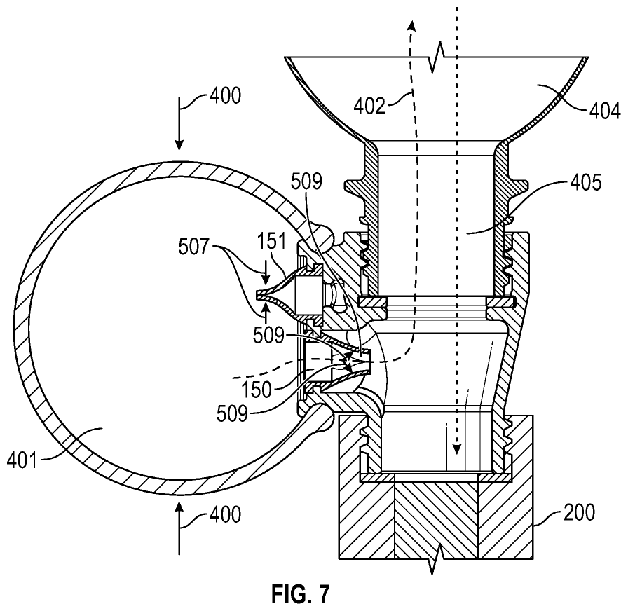

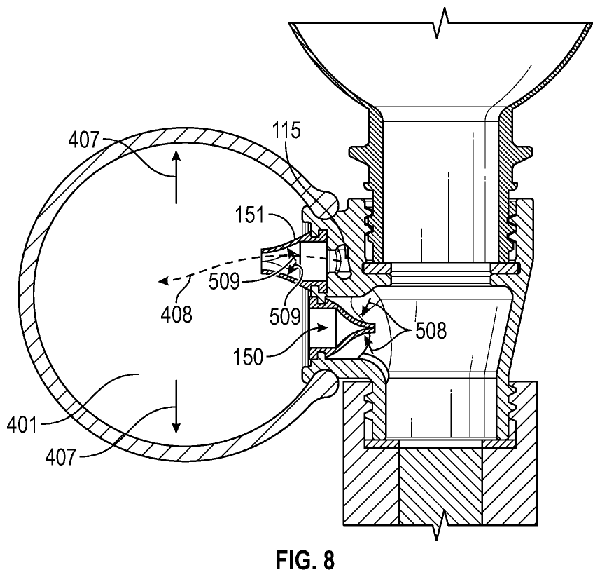

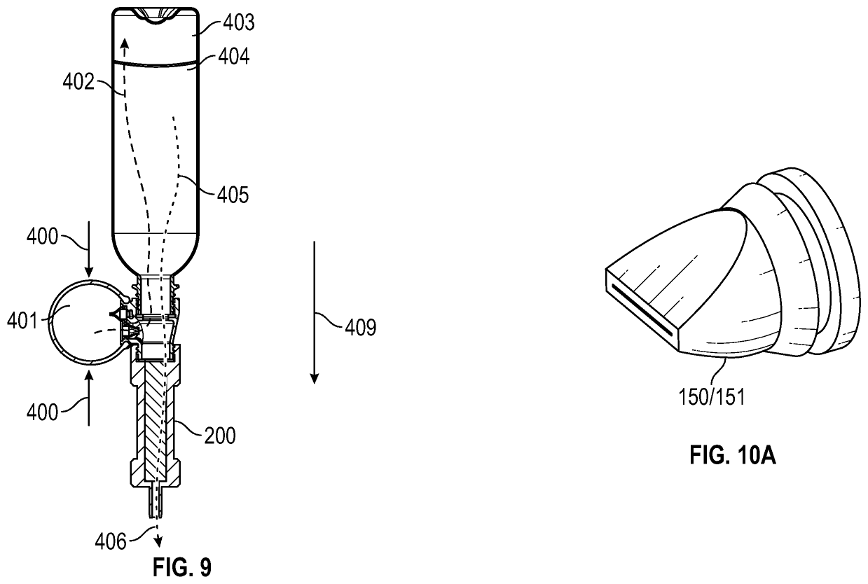

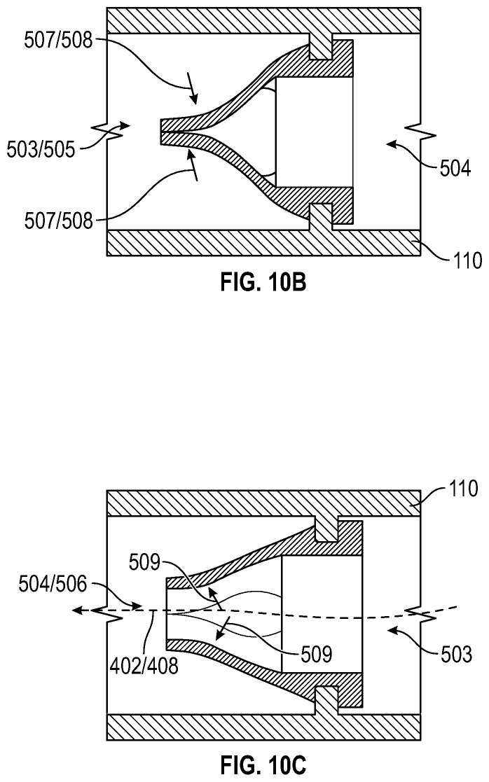

FIG. 7 and FIG. 9 present a more refined description, showing air from the pump bulb floating up to the top of the bottle, with added air pressure from the bottle adding the water pressure applied to the starting or superior end of the water filter.

The circular bulb retaining groove may define a circular area upon the housing. The intake valve and/or return valve may be disposed within the circular area and/or the interior area of the pump bulb.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system of water pressurization, the system comprising a housing:
a) the housing defining an inlet connection the inlet connection in fluid connection to an inner void, the inner void defined by the housing, the inner void in fluid connection with a supply valve;
b) a pump bulb in elastic or frictional attachment to the housing; and
c) the inner void in fluid connection with an outlet connection, the outlet connection defined by the housing.

2. The system of claim 1 wherein the supply valve is disposed within the housing.

3. The system of claim 2 wherein the housing further defines a circular or similarly shaped bulb retaining groove.

4. The system of claim 3 wherein the retaining groove defines an interior area upon the housing.

5. The system of claim 4 wherein the housing further defines a return air void, the return air void having a first end opening within the retaining groove interior area and the first end opening in fluid connection with a return air valve, the return air void having a second opening in fluid connection with ambient air;

6. The system of claim 5 wherein the pump bulb defines an interior volume.

7. The system of claim 4 wherein the return air valve is molded into the pump bulb.

8. The system of claim 6 wherein the return valve and the supply valve are in fluid connection to the interior volume of the pump bulb.

9. The system of claim 8 wherein the supply valve allows the passage of air from the interior volume of the pump bulb into the interior void.

10. The system of claim 8 wherein the return valve allows the passage of ambient air into the interior volume of the pump bulb.

11. The system of claim 10 wherein a compression of the pump bulb urges air from the interior of the pump bulb to open the supply valve allowing the air from the pump bulb to move into the inner void, further causing the air from the pump bulb void to float upwardly through water contained within a water bottle, the water bottle attached to the inlet connection, the air from the pump bulb rising to the upper end of the water bottle, adding pressure to the water in the water bottle causing an increase in water pressure to water disposed over a water filter, the water filter attached to the outlet connection of the housing.

12. The system of claim 11 wherein a compressed pump bulb is restored to an original spherical or similar shape by ambient air drawn by resilient recovery of the compressed pump bulb, the ambient air entering though the return air void and the ambient air passing through the return air valve into the interior of the compressed pump bulb.

13. The system of claim 12 wherein the resilient recovery of the compressed pump bulb causes a negative air pressure within the compressed pump bulb which causes the return valve to open.

14. The system of claim 12 wherein the negative pressure of the compressed pump bulb causes the supply valve to close.

15. A method of pressurization to assist in filtering water, the method comprising the steps of:
a) using a housing:
i. the housing defining an inlet connection the inlet connection in fluid connection to an inner void, the inner void defined by the housing, the inner void in fluid connection with a supply valve;
ii. the housing further defining a circular or similarly shaped bulb retaining groove;
iii. the bulb retaining groove defining an interior area upon the housing;
iv. the housing further defining a return air void, the return air void having a first end opening within the retaining groove interior area and the first end opening in fluid connection with a return air valve, the return air void having a second opening in fluid connection with ambient air;
v. a pump bulb in elastic or frictional attachment to the bulb retaining groove;
vi. the inner void in fluid connection with an outlet connection, the outlet connection defined by the housing;
b) compressing the pump bulb to move air from the interior of the pump bulb to open the supply valve allowing the air from the pump bulb to move into the inner void, further causing the air from the pump bulb void to float upwardly through water contained within a water bottle, the water bottle attached to the inlet connection, the air from the pump bulb rising to the upper end of the water bottle, adding pressure to the water in the water bottle causing an increase in water pressure to water disposed over a water filter, the water filter attached to the outlet connection of the housing, the water moving through the water filter and exiting the water filter.

16. A system of pressurization to assist in filtering water, the system comprising a housing:
a) the housing defining an inlet connection the inlet connection in fluid connection to an inner void, the inner void defined by the housing, the inner void in fluid connection with a supply valve;
b) the housing further defining a circular or similarly shaped bulb retaining groove;
c) the bulb retaining groove defining an area upon the housing;
d) the housing further defining a return air void, the return air void having a first end opening within the retaining groove area and the first end opening in fluid connection with a return air valve, the return air void having a second opening in fluid connection with ambient air;
e) a pump bulb in elastic or frictional attachment to the bulb retaining groove; and
f) the inner void in fluid connection with an outlet connection, the outlet connection defined by the housing.
